(19) United States
(12) Patent Application Publication
(10) Pub. No.: US 2025/0075970 A1
(43) Pub. Date: Mar. 6, 2025

(54) Water Supply System for a Refrigeration Device, and Refrigeration Device

(71) Applicants: Hefei Midea Refrigerator Co., Ltd., Hefei (CN); Hefei Hualing Co., Ltd., Hefei (CN); Midea Group Co., Ltd., Foshan (CN)

(72) Inventors: Yunyun XIE, Hefei (CN); Hong ZUO, Hefei (CN); Zengqiang SI, Hefei (CN)

(21) Appl. No.: 18/948,340

(22) Filed: Nov. 14, 2024

Related U.S. Application Data
(63) Continuation of application No. PCT/CN2022/101598, filed on Jun. 27, 2022.

(30) Foreign Application Priority Data
May 16, 2022 (CN) 202210531479.6

(51) Int. Cl. F25D 23/12

(52) U.S. Cl. CPC F25D 23/12; F25D 2323/121

(57) ABSTRACT

A water supply system for a refrigeration device includes a water purification assembly, a first water path and a second water path; the first water path is suitable for connecting an external water source to a water inlet end of the water purification assembly; the second water path is connected to a water outlet end of the water purification assembly to selectively supply water from the water purification assembly to a water-usage device. The water purification assembly and water supply pipelines are configured to filter the external water source, and directly supply the water-usage device.

### CROSS-REFERENCES TO RELATED APPLICATIONS

The present application is a continuation of International (PCT) Patent Application No. PCT/CN2022/101598 filed on Jun. 27, 2022, which claims priority to Chinese Application No. 202210531479.6 filed on May 16, 2022, entitled “Water Supply System for Refrigeration Device, and Refrigeration Device,” which are incorporated herein by reference in their entirety.

### FIELD

The present application relates to the field of refrigeration device, and in particular to a water supply system for a refrigeration device and a refrigeration device.

### BACKGROUND

In the related art, a water supply system for a refrigeration device supplies part of the water purified by a water purification assembly to an ice maker, another part of the purified water is stored in a water tank, and then supplied from the water tank to a dispenser for users to use.

Connection pipelines of the water supply system may be relatively complicated and a flow path of the water supply system may be too long since mount positions of components such as the water tank, the ice maker and the dispenser in the refrigeration device are relatively scattered and it may not be convenient to repair and replace the water supply system.

### SUMMARY

The present application is intended to solve at least one of problems above. The present application provides a water supply system for a refrigeration device, which integrates the water supply system, and various components are centrally provided to simplify the design of water supply pipelines and shorten a water supply path, which is not only convenient for repairing and replacing parts of the water supply system, but also improves the reliability of the water supply system.

The present application further provides a refrigeration device.

A water supply system for a refrigeration device according to some embodiments of the present application includes: a water purification assembly, a first water path, for connecting an external water source to a water inflow end of the water purification assembly, a valve component, where a liquid inlet of the valve component is connected to a water outflow end of the water purification assembly, and a second water path, connected to a liquid outlet of the valve component to selectively supply water from the water purification assembly to a water-usage device.

According to the water supply system of some embodiments of the present application, through the water purification assembly and each water supply pipeline, it is possible to filter the external water source and directly supply the filtered water to the water-usage device, integrate the water supply system, and various components are centrally provided to simplify the water supply path. It is not only convenient for repairing and replacing parts of the water supply system, but also improves the reliability of the water supply system.

According to some embodiments of the present application, the water supply system further includes: a valve component, where the liquid inlet of the valve component is connected to the water outflow end of the water purification assembly, and the liquid outlet of the valve component is connected to the second water path.

According to some embodiments of the present application, the second water path includes a first water supply pipe assembly and a second water supply pipe, where the first water supply pipe assembly is used for connecting the valve component to an ice maker unit of the water-usage device, and the second water supply pipe is used for connecting the valve component to a dispenser of the water-usage device.

According to some embodiments of the present application, the ice maker unit includes a first ice maker provided at a refrigeration compartment and a second ice maker provided at a freezer compartment, and the first water supply pipe assembly includes a first water supply sub-pipe and a second water supply sub-pipe, the first water supply sub-pipe is used for connecting the valve component to the first ice maker, and the second water supply sub-pipe is used for connecting the valve component to the second ice maker.

According to some embodiments of the present application, the water purification assembly includes an outer housing assembly, provided with an accommodation cavity, a filter element, provided inside the accommodation cavity; an inner housing, provided between the outer housing assembly and the filter element, where a first flow duct is provided between the inner housing and the outer housing assembly, the first flow duct communicates with a main water inlet, and the main water inlet communicates with the first water path; a second flow duct is provided between the inner housing and the filter element; a third flow duct is provided inside the filter element, the third flow duct communicates with a main water outlet, and the main water outlet communicates with the second water path, and a support member, for supporting the filter element, where a water storage cavity is provided between the support member and a bottom wall of the outer housing assembly, and the water storage cavity communicates with the first flow duct and the second flow duct respectively.

In this embodiment, the water storage cavity for storing water is provided at the water purification assembly, the integration degree of the water purification assembly is higher, and the water purification assembly has not only a purification function but also a water storage function. The water tank provided at the independent water purification assembly in the related art is replaced with the water storage cavity, that is, the water tank is removed, the design of the structure is simplified and the occupation space of the structure is reduced. Simultaneously, connection pipelines and connection joints between the water tank and the water purification assembly are removed, the risk of water leakage of the structure is effectively avoided, and the product is more reliable.

According to some embodiments of the present application, at least one of the first flow duct and the second flow duct is provided with a guide portion, and the guide portion extends along a central axis of the inner housing to form a spiral structure.

According to some embodiments of the present application, the water supply system further includes an adapter seat assembly, and the adapter seat assembly includes, an adapter seat body, where the main water inlet and the main water outlet are provided at the adapter seat body, and the adapter seat body is further provided with a bypass cavity, a dispense cavity and a work cavity, the bypass cavity communicates with the work cavity through the dispense cavity, and the work cavity is used for being detachably connected to the water purification assembly, and a valve core component, movably provided at the dispense cavity and is switchable between a first position and a second position, in the first position, the valve core component turns off the dispense cavity and the work cavity, and the main water inlet communicates with the main water outlet through the dispense cavity and the bypass cavity, and in the second position, the valve core component turns off the dispense cavity and the bypass cavity, and the main water inlet communicates with the main water outlet through the dispense cavity and the work cavity.

According to some embodiments of the present application, the water supply system further includes a water stop component, where a water stop cavity is provided inside the outer housing assembly, the water stop component is movably provided at the water stop cavity, and is switchable between a first position and a second position, a first duct is provided outside the water stop component, a second duct is provided inside the water stop component, and a check valve is provided at the second duct, in the first position, the water stop component turns off the first duct, and the check valve turns off the second duct, and in the second position, the water stop component turns on the first duct, and the check valve turns on the second duct.

A refrigeration device according to the present application includes a refrigeration compartment, a water-usage device, and a water supply system for refrigeration device as described above, the water purification assembly is provided at the refrigeration compartment, the liquid inlet of the valve component communicates with the main water outlet of the water purification assembly, and the liquid outlet of the valve component communicates with at least one of the water-usage devices.

According to some embodiments of the present application, the water-usage devices include a first ice maker, a second ice maker and a dispenser, the refrigeration compartment includes a refrigerator compartment and a freezer compartment, the first ice maker is provided at the refrigerator compartment, the second ice maker is provided at the freezer compartment, and the dispenser is provided at a door body of the refrigeration device.

According to the refrigeration device of some embodiments of the present application, through the water purification assembly, the valve component and each water supply pipeline, it is possible to filter the external water source and selectively supply the filtered water to the water-usage device, integrate the water supply system and various components are centrally provided to simplify the water supply path. It is not only convenient for repairing and replacing parts of the water supply system, but also improves the reliability of the water supply system.

The additional aspects and advantages of the present application will be set forth in part in the description which follows and, in part, will be apparent from the description, or may be learned by practice of the present application.

### BRIEF DESCRIPTION OF THE DRAWINGS

To more clearly illustrate solutions disclosed in some embodiments of the present application, the drawings used in the descriptions of some embodiments will be briefly described below. The drawings in the following description are only certain embodiments of the present application, and other drawings may be obtained based on these drawings without any creative work for those skilled in the art.

FIG. 1 is a cross-sectional view of a water purification assembly according to some embodiments of the present application;

FIG. 2 is an explosive schematic structural diagram of a water purification assembly according to some embodiments of the present application;

FIG. 3 is a front view of a water purification assembly according to some embodiments of the present application;

FIG. 4 is a schematic diagram of a state in which an adapter seat assembly of a water purification assembly is in a first position according to some embodiments of the present application;

FIG. 5 is a schematic diagram of a state in which an adapter seat assembly of a water purification assembly is in a second position according to some embodiments of the present application;

FIG. 6 is a schematic diagram of a state in which a water stop component of a water purification assembly is in a first position according to some embodiments of the present application;

FIG. 7 is a schematic diagram of a state in which a water stop component of a water purification assembly is in a second position according to some embodiments of the present application;

FIG. 8 is a schematic structural diagram of a refrigeration device according to some embodiments of the present application; and

FIG. 9 is a schematic structural diagram of a water supply system for refrigeration device according to some embodiments of the present application.

### REFERENCE NUMERALS

100: water purification assembly;
101: outer housing assembly; 1011: first outer housing; 1011-1: first seal ring; 1011-2: water stop cavity; 1012: second outer housing; 1013: first flow duct; 1014: second flow duct;
102: inner housing; 1021: flow guide portion; 1022: limit protrusion; 1023: second seal ring; 1024: fixation portion; 1025: guide protrusion;
103: filter element; 1031: third flow duct; 1032: second block member; 1032-1: third seal ring;
104: support member; 1041: water storage cavity; 1042: support member body; 1042-1: first end; 1042-2: second end; 1042-3: first water inlet; 1042-4: first water outlet; 1042-5: limit portion; 1043: limit block; 1044: first block member; 1044-1: block groove; 1044-2: protrusion;
105: adapter seat assembly; 1051: main water inlet; 1052: main water outlet; 1053: bypass cavity; 1054: dispense cavity; 1054-1: first dispense cavity body; 1054-2: second dispense cavity body; 1055: work cavity; 1056: valve core component; 1056-1: first ejector rod; 1056-2: second ejector rod; 1056-3: first elastic member; 1056-4: second elastic member; 1057: fourth seal ring; 1058: fifth seal ring;
106: fixation seat; 1061: first seat body; 1062: second seat body;
107: water stop component; 1071: water stop housing; 1071-1: limit groove; 1071-2: sixth seal ring; 1071-3: seventh seal ring; 1072: elastic member; 1073: check valve; 1074: first duct; 1075: second duct; 1076: seal protrusion;
200: valve component;
300: first water path;
400: second water path; 401: first water supply sub-pipe; 402: second water supply sub-pipe; 403: second water supply pipe;
500: water-usage device; 501: first ice maker; 502: second ice maker; 503: dispenser;
600: refrigeration device; 601: refrigerator compartment; 602: freezer compartment;
603: door body.

### DETAILED DESCRIPTION

Embodiments of the present application are further described in detail below with reference to the drawings and embodiments. The following embodiments are intended to illustrate the application, but are not intended to limit the scope of the application.

In the description of some embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing some embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance.

In the description of the present application, it should be noted that unless explicitly specified and defined otherwise, the terms “connected to” and “connected” shall be understood broadly, for example, it may be either fixedly connected or detachably connected, or can be integrated; it may be either mechanically connected, or electrically connected; it may be either directly connected, or indirectly connected through an intermediate medium. The specific meanings of the terms above in the present application can be understood by a person skilled in the art in accordance with specific conditions.

In some embodiments of this application, unless otherwise clearly stated and defined, the first feature being located “on” or “under” the second feature means that the first feature is in direct contact with the second feature or the first feature is in contact with the second feature by an intervening media. In addition, the first feature is “on”, “above” and “over” the second feature can refer to that the first feature is directly above or obliquely above the second feature, or simply refer to that the level height of the first feature is higher than that of the second feature. The first feature is “under”, “below” and “beneath” the second feature can refer to that the first feature is directly below or obliquely below the second feature, or simply refer to that the level height of the first feature is lower than that of the second feature.

In the description of this specification, description with reference to the terms “one embodiment”, “some embodiments”, “an example”, “specific example”, “some examples” and the like, refers to that specific features, structures, materials or characteristics described in combination with some embodiments or an example are included in at least one embodiment or example according to some embodiments of the present application. In this specification, schematic representations of the above terms are not necessarily directed to a same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

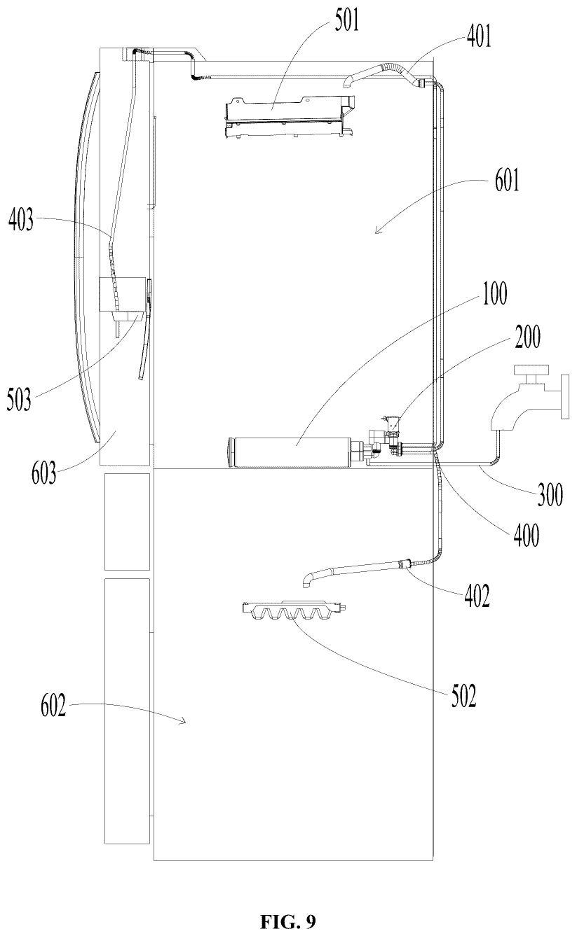

Referring to FIG. 8 and FIG. 9 in detail, a water supply system for refrigeration device 600 provided by some embodiments of the present application includes a water purification assembly 100, a first water path 300 and a second water path 400.

The first water path 300 may be used for connecting an external water source to a water inlet end of the water purification assembly 100, and is used for supplying water to the water purification assembly 100. The second water path 400 is connected to a water outflow end of the water purification assembly 100, and may selectively supply water from the water purification assembly 100 to a water-usage device 500.

Referring to FIG. 8 and FIG. 9 in detail, in some embodiments, the water-usage device 500 may be one or multiple. The number of water-usage devices 500 is selected according to the use requirements of different users.

When the number of water-usage devices 500 is one, the water supply system for the refrigeration device includes the water purification assembly 100, the first water path 300 and the second water path 400.

The first water path 300 may be used for connecting an external water source to a water inlet end of the water purification assembly 100, and used for supplying water to the water purification assembly 100. The second water path 400 is connected to a water outflow end of the water purification assembly 100, and may directly supply water from the water purification assembly 100 to the water-usage device 500.

When the number of the water-usage devices 500 is multiple, for example, the water-usage devices 500 include an ice maker unit and a dispenser 503, the water supply system for the refrigeration device includes the water purification assembly 100, the first water path 300, a valve component 200 and the second water path 400.

The first water path 300 may be used for connecting an external water source to a water inlet end of the water purification assembly 100, and used for supplying water to the water purification assembly 100. A liquid inlet of the valve component 200 is connected to a water outflow end of the water purification assembly 100 and used for dispensing water filtered by the water purification assembly 100. The second water path 400 is connected to a liquid outlet of the valve component 200 to selectively supply water from the water purification assembly 100 to the water-usage device 500.

As shown in FIG. 9, in some embodiments, the second water path 400 includes a first water supply pipe assembly and a second water supply pipe 403, where the first water supply pipe assembly is used for connecting the valve component 200 to an ice maker unit and conveying water dispensed by the valve component 200 to the ice maker unit, and the second water supply pipe 403 is used for connecting the valve component 200 to the dispenser 503 and conveying water dispensed by the valve component 200 to the dispenser 503.

As shown in FIG. 9, in some embodiments, the ice maker unit includes a first ice maker 501 and a second ice maker 502. The first water supply pipe assembly includes a first water supply sub-pipe 401 and a second water supply sub-pipe 402, the first water supply sub-pipe 401 is used for connecting the valve component 200 to the first ice maker 501, and the second water supply sub-pipe 402 is used for connecting the valve component 200 to the second ice maker 502.

Through the water supply system for the refrigeration device 600 provided by some embodiments of the present application, the parts of the water path system are highly integrated, the connection points between the pipes are reduced compared with the water supply system of the related art, the risk of water leakage caused by loose joints is decreased, and the length of the water supply system is shortened, which is convenient for replacement and maintenance of the water path system.

By improving the water purification assembly 100, the water path system is streamlined. After the water purification assembly 100 is replaced, the replacement of the water storage space in the entire water system may be completed, which further ensures the safety of water usage for users.

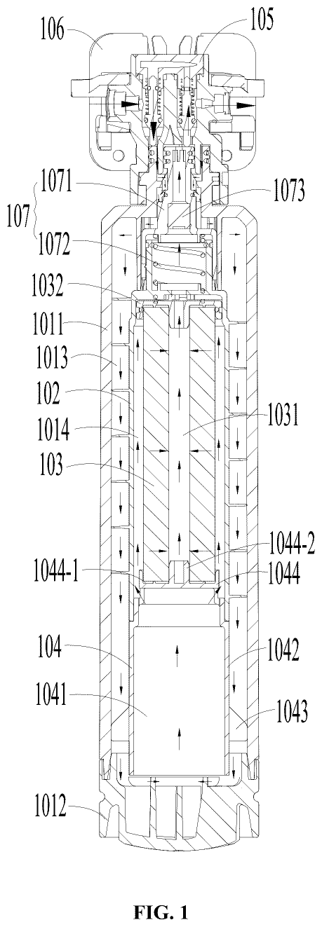

Referring to FIG. 1 in detail, in some embodiments, the water purification assembly 100 includes an outer housing assembly 101, a filter element 103, an inner housing 102 and a support member 104. An accommodation cavity is provided inside the outer housing assembly 101, and the filter element 103 is provided inside the accommodation cavity. The inner housing 102 is provided between the outer housing assembly 101 and the filter element 103, where a first flow duct 1013 through which water may flow is provided between the inner housing 102 and the outer housing assembly 101, and a second flow duct 1014 through which water may flow is provided between the inner housing 102 and the filter element 103.

The support member 104 is mainly used for axial support for the filter element 103, and there is a certain space between the filter element 103 and a bottom wall of the outer housing assembly 101. That is, a water storage cavity 1041 is provided between the filter element 103 and the bottom wall of the outer housing assembly 101, and the water storage cavity 1041 communicates with the first flow duct 1013 and the second flow duct 1014 respectively. A third flow duct 1031 is provided inside the filter element 103, that is, the filter element 103 is located between the second flow duct 1014 and the third flow duct 1031.

The first flow duct 1013 may be either a water inflow duct or a water outflow duct, the second flow duct 1014 may be either a water inflow duct or a water outflow duct, and the third flow duct 1031 may also be either a water inflow duct or a water outflow duct.

When both the first flow duct 1013 and the second flow duct 1014 are water inflow ducts, and the third flow duct 1031 is the water outflow duct, the first flow duct 1013 may communicate with the main water inlet 1051 of the water purification assembly 100, and the third flow duct 1031 may communicate with the main water outlet 1052 of the water purification assembly 100.

During the working of the water purification assembly 100, the main water inlet 1051 communicates with the external water source. The water flows from the main water inlet 1051 into the first flow duct 1013, passes through the first flow duct 1013, and enters the water storage cavity 1041 for storage. When a user needs to use purified water, the water stored in the water storage cavity 1041 first flows from the water storage cavity 1041 into the second flow duct 1014, enters the third flow duct 1031 from the second flow duct 1014 through the filter element 103, and finally is conveyed to the main water outlet 1052 by the third flow duct 1031.

In some embodiments, by providing the water storage cavity 1041 for storing water and the water ducts inside the water purification assembly 100, the integration degree of the water purification assembly 100 is higher, and the water purification assembly 100 has not only a purification function but also a water storage function. The water tank structure provided at the independent water purification assembly 100 in the related art is replaced with the water storage cavity, that is, the water tank is removed, the design of the structure is simplified and the occupation space of the structure is reduced. Simultaneously, connection pipelines and connection joints between the water tank and the water purification assembly 100 are removed, the risk of water leakage of the structure is effectively avoided, and the product is more reliable.

Referring to FIG. 1, in some embodiments, the support member 104 may be limited to an inner wall surface of the outer housing assembly 101, and the water storage cavity 1041 is formed inside the support member 104. It is equivalent to the support member 104 being snapped or overlapped on the inner wall surface of the outer housing assembly 101, to prevent the filter element 103 from continuing to extend into the bottom wall of the outer housing assembly 101. There is a certain space between the bottom wall of the outer housing assembly 101 and the support member 104, and the water storage cavity 1041 is then formed.

After the water passes through the first flow duct 1013 and enters the water storage cavity 1041, the water may be temporarily stored in the water storage cavity 1041, and the water storage cavity 1041 is equivalent to a water tank for storing water. Part of the water in the water storage cavity 1041 enters the second flow duct 1014, and then penetrates from the second flow duct 1014 to the filter element 103 for being filtered, and the water filtered by the filter element 103 flows out from the third flow duct 1031 inside the filter element 103.

By integrating the water storage cavity 1041 in the water purification assembly 100 for storing water, the structural arrangement of the water tank is removed, and the connection pipelines and connection joints between the water tank and the water purification assembly 100 are eliminated, which simplifies the structure, reduces the occupation space of the structure, and effectively avoids the risk of water leakage. In addition, when the water is purified, an input side of the filter element 103 is fully immersed in the water environment since the water storage cavity 1041 is integrated inside the water purification assembly 100, and it ensures that the filter element 103 has a better purification effect on the water.

Referring to FIG. 1, in some embodiments, the structure and shape of the support member 104 are compatible with the structure and shape of the filter element 103 and the inner housing 102. When both the inner housing 102 and the filter element 103 have cylindrical structures, the support member 104 may also have a cylindrical structure. The support member 104 is fixedly provided at the inner wall surface of the inner housing 102. A first side of the support member 104 may abut against the filter element 103 to block a first end of the filter element 103; a second side of the support member 104 may form a space for storing water, that is, the water storage cavity 1041, together with part of the inner wall surface of the outer housing assembly 101 and the bottom wall of the outer housing assembly 101.

Simultaneously, a stopper (not shown in the figure) may be provided at the inner wall surface of the outer housing assembly 101 to limit the axial support of the inner housing 102. As such, an end surface of one end of the inner housing 102 is flush with the surface of the support member 104 facing the water storage cavity 1041, and the water passing through the first flow duct 1013 may directly enter the water storage cavity 1041 for storage. In addition, a plurality of first water outlets 1042-4 are provided at the support member 104, and each first water outlet 1042-4 communicates with the second flow duct 1014, and the water in the water storage cavity 1041 passes through the first water outlets 1042-4 and then enters the second flow duct 1014.

Referring to FIG. 1, in some embodiments, the inner housing 102 may extend to the bottom wall of the outer housing assembly 101, and there is a water-passing gap with the inner wall surface of the outer housing assembly 101. It means that the water storage cavity 1041 is separated from the first flow duct 1013, the water in the second flow duct 1014 continues to enter the water-passing gap, and enters the water storage cavity 1041 from the water-passing gap. It also means that the water inlet path is prolonged, the water first entering the water storage cavity 1041 first flows out from the first water outlet 1042-4 of the water storage cavity 1041, which is conducive to the water first entering the water purification module being filtered first and then flowing out of the water quality evolution module, which may prevent stale water from storing.

An opening may be provided at an end of the bottom of the inner housing 102 proximal to the outer housing assembly 101, that is, a plurality of openings may be provided at the side wall or end surface of the inner housing 102 to form the first water inlet 1042-3 of the water storage cavity 1041.

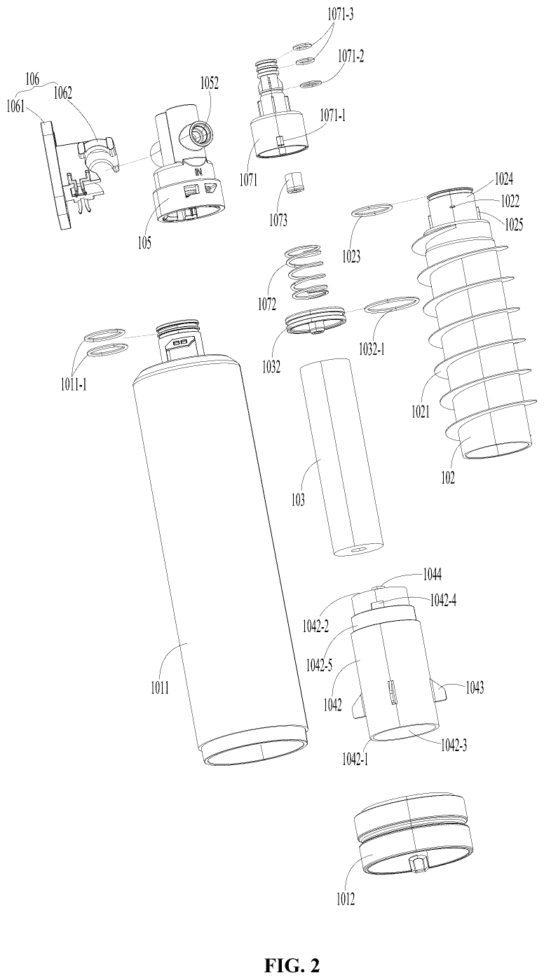

Referring to FIG. 2, in some embodiments, the structure and shape of the support member 104 are compatible with the structure and shape of the filter element 103 and the inner housing 102, etc., and may be a cylindrical structure for axially supporting the filter element 103 and blocking an end of the filter element 103. The interior of the support member 104 is a hollow structure to form a water flow duct and a water storage space.

The support member 104 includes a support member body 1042 and a limit block 1043. The limit block 1043 is provided at an outer side wall of the support member body 1042, and the limit block 1043 is equivalent to a connection lug of the support member body 1042 for abutting against or overlapping with the inner wall surface of the outer housing assembly 101 to fix the support member body 1042.

The support member body 1042 has a first end 1042-1 and a second end 1042-2. The first end 1042-1 is provided with a first water inlet 1042-3. The first water inlet 1042-3 communicates with the first flow duct 1013, and the water in the first flow duct 1013 may pass through the first water inlet 1042-3 and enter the water storage cavity 1041. The second end 1042-2 abuts against the filter element 103, and is used for blocking an end of the filter element 103. The water in the water storage cavity 1041 may enter the third flow duct 1031 inside the filter element 103 after being filtered by the filter element 103.

The outer wall surface of the support member body 1042 may be flush with the outer wall surface of the inner housing 102, and there is a water-passing gap between the support member body 1042 and the inner housing 102. As such, the water in the second flow duct 1014 continues to enter the water-passing gap and enters the first water inlet 1042-3 of the water storage cavity 1041 from the water-passing gap, which means that the water inlet path is prolonged. The water first entering the water storage cavity 1041 first flows out from the first water outlet 1042-4 of the water storage cavity 1041, which is conducive to the water first entering the water purification module being filtered first and then flowing out of the water quality evolution module, which may prevent stale water from storing.

Referring to FIG. 1 and FIG. 2, in some embodiments, the second end 1042-2 of the support member body 1042 is provided with a first block member 1044 and the first block member 1044 abuts against the filter element 103 to block an end of the filter element 103. As such, the water in the water storage cavity 1041 enters the third flow duct 1031 inside the filter element 103 after being filtered by the filter element 103. The first block member 1044 may be provided independent of the support member 104, and may be fixedly connected or detachably connected to the second end 1042-2 of the support member 104.

As shown in FIG. 2, the support member body 1042 and the first block member 1044 may also be integrally formed, a block groove 1044-1 is provided at a side of the first block member 1044 facing the filter element 103, and the filter element 103 may be embedded in the block groove 1044-1. It means that the outer wall surface of the filter element 103 and the inner wall of the block groove 1044-1 are in interference fit to seal. A seal member may also be provided between the block groove 1044-1 and the filter element 103 to hermetically connect the filter element 103 to the block groove 1044-1.

A protrusion is provided inside the block groove 1044-1. After the filter element 103 is embedded in the block groove 1044-1, a protrusion 1044-2 extends into the third flow duct 1031, which may make the turn-off effect of the first block member 1044 better and avoid water leakage at the end of the filter element 103.

Referring to FIG. 1 and FIG. 2, in some embodiments, a limit portion 1042-5 is provided at the outer wall of the support member body 1042, and the inner housing 102 abuts against the limit portion 1042-5 for limiting the inner housing 102 from continuing to approach the bottom wall of the outer housing assembly 101, and playing an axial support role for the inner housing 102.

A first water outlet 1042-4 is provided at the side wall between the limit portion 1042-5 and the second end 1042-2 of the support member body 1042, and the first water outlet 1042-4 communicates with the second flow duct 1014. It means that the water outlet direction is oblique to the side wall of the support member body 1042, and the water flowing out of the water storage cavity 1041 flows into the second flow duct 1014 more smoothly.

The support member 104 is not only for the axial support of the filter element 103, but also for the axial support of the inner housing 102, and the number of parts of the water purification assembly 100 is decreased to further simplify the structure of the water purification assembly 100.

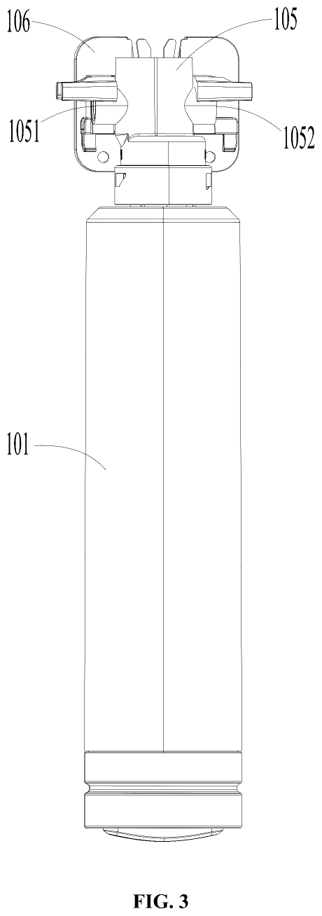

Referring to FIG. 1, FIG. 2 and FIG. 3, in some embodiments, the outer housing assembly 101 includes a first outer housing 1011 and a second outer housing 1012, and the first outer housing 1011 is detachably connected to the second outer housing 1012. That is, the first outer housing 1011 may be in interference fit, snap-fit or threaded connection with the second outer housing 1012, which ensures the seal property between the first outer housing 1011 and the second outer housing 1012.

By detachably connecting the first outer housing 1011 and the second outer housing 1012, the parts inside the water purification assembly 100 may be replaced by disassembling the first outer housing 1011 and the second outer housing 1012, which facilitates the maintenance and replacement of the water purification assembly 100.

Referring to FIG. 1, in some embodiments, a radial spacing of the first flow duct 1013 is greater than a radial spacing of the second flow duct 1014, which ensures a large water inlet volume and a small water outlet volume, and the water storage cavity 1041 is in a state of dynamic balance.

The radial spacings may be understood as a spacing between an inner wall surface of the first outer housing 1011 and an outer wall surface of the inner housing 102, and a spacing between the outer wall surface of the filter element 103 and the inner wall surface of the inner housing 102.

Referring to FIG. 1 and FIG. 2, in some embodiments, in order to prolong a flow path of the water in the water purification assembly 100, a flow guide portion 1021 is provided between the inner housing 102 and the first outer housing 1011, and the flow guide portion 1021 may extend along the central axis of the inner housing 102 to form a spiral structure. The first flow duct 1013 is provided as a spiral flow duct, a first end of the spiral flow duct communicates with a main water inlet 1051, and a second end of the spiral flow duct communicates with the first water inlet 1042-3 of the water storage cavity 1041.

By providing a flow guide portion 1021 between the first outer housing 1011 and the inner housing 102, the first flow duct 1013 forms a spiral flow duct. When the water is supplied from the main water inlet 1051, it flows to the water storage cavity 1041 along the extension direction of the spiral flow duct. It means that the flow path of the water is prolonged by the spiral flow duct, the water first flowing into the water purification assembly 100 flows out of the water purification assembly 100 first. That is, the first-in-first-out of the water is realized, which may effectively prevent the accumulation of stale water and the occurrence of mixed water.

Furthermore, by prolonging the flow path of the water, a heat exchange area between the water in the spiral flow duct and the outside is increased to accelerate the cooling of the water in the water purification assembly 100, and the cooling effect of the water is better. Simultaneously, the spiral flow duct may effectively prevent the backflow phenomenon along the spiral flow duct due to external factors during the flow of the water.

Referring to FIG. 1 and FIG. 2, in some embodiments, the flow guide portion 1021 may be provided at the inner wall surface of the first outer housing 1011 or at the outer wall surface of the inner housing 102, or the flow guide portion 1021 may be sandwiched between the inner wall surface of the first outer housing 1011 and the outer wall surface of the inner housing 102.

That is, the flow guide portion 1021 is provided in at least one of the first flow duct 1013 and the second flow duct 1014. The flow guide portion 1021 is provided at the first flow duct 1013 or the second flow duct 1014, or the flow guide portion 1021 may be provided at both the first flow duct 1013 and the second flow duct 1014, and the flow guide portion 1021 extends along the central axis of the inner housing 102 to form a spiral structure.

An axial length of the flow guide portion 1021 extending along the central axis of the inner housing 102 is less than an axial length of the inner housing 102. For example, the axial length of the flow guide portion 1021 extending along the central axis of the inner housing 102 is equal to one-half or two-thirds of the axial length of the inner housing 102, etc. That is, the flow guide portion 1021 is provided at part of the outer wall surface of the inner housing 102.

To further enhance the water anti-mixing effect, the flow guide portion 1021 may be provided at the entire outer wall of the inner housing 102. That is, the axial length of the flow guide portion 1021 extending along the central axis of the inner housing 102 is equal to the axial length of the inner housing 102.

It should be noted that the filter element 103 may be either an activated carbon rod filter element 103 or a filter element 103 wound by a reverse osmosis membrane as known in the art, and any purification core material that may achieve water filtration is available.

Referring to FIG. 1 to FIG. 5, in some embodiments, the water purification assembly 100 further includes an adapter seat assembly 105, and the adapter seat assembly 105 includes an adapter seat body and a valve core component 1056 provided at the adapter seat body.

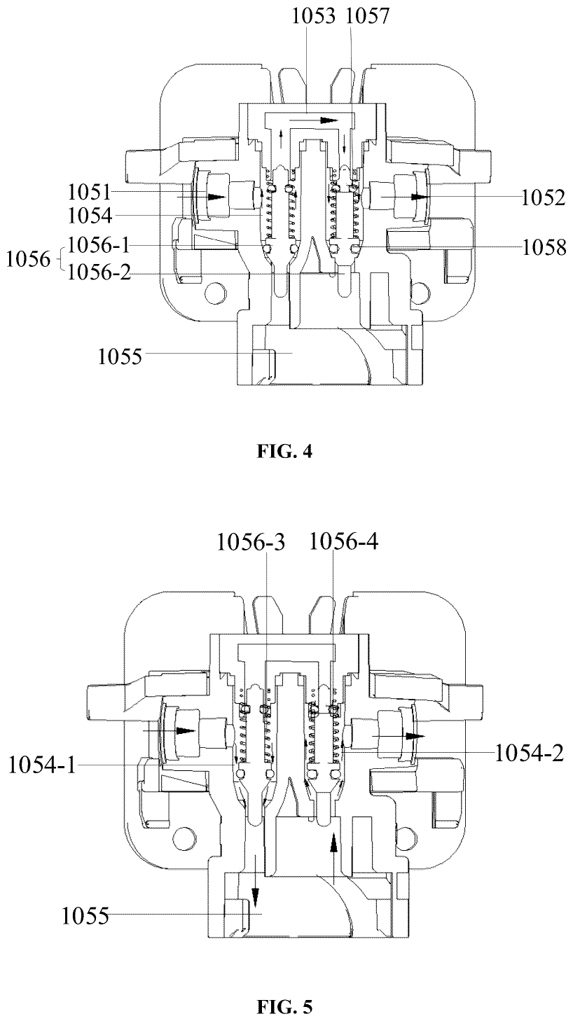

As shown in FIG. 3, FIG. 4 and FIG. 5, the main water inlet 1051 and the main water outlet 1052 are provided at the adapter seat body. In addition, the adapter seat body is a hollow housing structure, and is further provided therein with a bypass cavity 1053, a dispense cavity 1054 and a work cavity 1055. The bypass cavity 1053 communicates with the work cavity 1055 through the dispense cavity 1054, and the adapter seat assembly is detachably connected to the water purification assembly 100 through the work cavity 1055.

It should be noted that the main water inlet 1051 and the main water outlet 1052 do not limit a specific water flow direction. For example, the main water inlet 1051 may enable water to flow in or enable water to flow out. Similarly, the main water outlet 1052 may enable water to flow in or enable water to flow out, and the specific arrangement is selected based on actual use needs.

As shown in FIG. 4 and FIG. 5, in some embodiments, the valve core component 1056 is movably provided at the dispense cavity 1054 and is switchable between a first position and a second position.

As shown in FIG. 4, when the valve core component 1056 is in the first position, the valve core component 1056 turns off the dispense cavity 1054 and the work cavity 1055, which means that the dispense cavity 1054 does not communicate with the work cavity 1055. The main water inlet 1051, the dispense cavity 1054, the bypass cavity 1053 and the main water outlet 1052 communicate with each other.

As shown in FIG. 5, when the valve core component 1056 is in the second position, the valve core component 1056 turns off the dispense cavity 1054 and the bypass cavity 1053, which means that the dispense cavity 1054 does not communicate with the bypass cavity 1053, and the main water inlet 1051, the dispense cavity 1054, the work cavity 1055 and the main water outlet 1052 communicate with each other.

Referring to FIG. 4, in some embodiments, the main water inlet 1051 may be connected to an external water source through a water pipe, and the external water source may be tap water or well water, etc. The main water outlet 1052 is connected to the water-usage device 500 or the valve component 200 through a water pipe, and the water-usage device 500 may be the first ice maker 501, the second ice maker 502 and the dispenser 503, etc. By controlling the position of the valve core component 1056 in the dispense cavity 1054, the dispense cavity 1054 is adjusted to turn on the bypass cavity 1053, and the main water inlet 1051 communicates with the main water outlet 1052 through the dispense cavity 1054 and the bypass cavity 1053, which ensures that the water path between the main water inlet 1051 and the main water outlet 1052 communicates, and water overflow is avoided when the filter element 103 is replaced.

Referring to FIG. 5, in some embodiments, by controlling the position of the valve core component 1056 in the dispense cavity 1054, the dispense cavity 1054 is adjusted to turn on the work cavity 1055, the main water inlet 1051 communicates with the main water outlet 1052 of the water purification assembly 100 through the dispense cavity 1054 and the work cavity 1055. At this time, it means that the water purification assembly 100 is in a working state, that is, the external water source may enter from the main water inlet 1051, pass through the dispense cavity 1054 and the work cavity 1055 in turn, enter the water purification assembly 100 for being filtered, and then flow out from the main water outlet 1052 after being filtered.

During use, if the filter element 103 is to be replaced or repaired, as shown in FIG. 4, the water purification assembly 100 may be dissembled from the adapter seat assembly 105. At this time, the water purification assembly 100 is disconnected from the work cavity 1055 of the adapter seat assembly 105. To ensure the normal working of the water system, the valve core component 1056 is moved to the first position, that is, the position shown in FIG. 4. The valve core component 1056 turns off the dispense cavity 1054 and the work cavity 1055, and the main water inlet 1051 communicates with the main water outlet 1052 through the dispense cavity 1054 and the bypass cavity 1053. As such, the external water source enters the dispense cavity 1054 through the main water inlet 1051, then enters the bypass cavity 1053 from the dispense cavity 1054, and finally flows out from the main water outlet 1052. The water path between the main water inlet 1051 and the main water outlet 1052 communicates to prevent water from overflowing when the filter element 103 is replaced, and the filter element replacement experience of the user is improved.

When the water purification assembly 100 is assembled on the adapter seat assembly 105, that is, the water purification assembly 100 communicates with the work cavity 1055 of the adapter seat assembly 105, the valve core component 1056 is moved to the second position, as shown in FIG. 5, the valve core component 1056 turns off the dispense cavity 1054 and the bypass cavity 1053, and the main water inlet 1051 communicates with the main water outlet 1052 through the dispense cavity 1054 and the work cavity 1055. As such, the external water source enters the dispense cavity 1054 through the main water inlet 1051, and then the water enters the water purification assembly 100 after passing through the work cavity 1055 for being filtered, and flows out from the main water outlet 1052 after being filtered.

In some embodiments of the present application, by providing the adapter seat assembly 105 including the adapter seat body and the valve core component 1056 disposed in the adapter seat body at the water purification assembly 100, the bypass cavity 1053, the dispense cavity 1054 and the work cavity 1055 are provided inside the adapter seat body, and the bypass cavity 1053 communicates with the work cavity 1055 through the dispense cavity 1054; the adapter seat assembly is detachably connected to the water purification assembly 100 through the work cavity 1055. The valve core component 1056 may be movably provided at the dispense cavity 1054, and may be switchable between the first position and the second position. When the valve core component 1056 is in the first position, the valve core component 1056 turns off the dispense cavity 1054 and the work cavity 1055, and the main water inlet 1051 communicates with the main water outlet 1052 using the dispense cavity 1054 and the bypass cavity 1053. When the filter element 103 is replaced, the water path may be kept smooth without affecting the user's use to improve the user experience.

Referring to FIG. 4 and FIG. 5, in some embodiments, the dispense cavity 1054 includes a first dispense cavity body 1054-1 and a second dispense cavity body 1054-2 provided at parallel. The first dispense cavity body 1054-1 communicates with the main water inlet 1051, the second dispense cavity body 1054-2 communicates with the main water outlet 1052. A first end of the bypass cavity 1053 communicates with the work cavity 1055 through the first dispense cavity body 1054-1, and a second end of the bypass cavity 1053 communicates with the work cavity 1055 through the second dispense cavity body 1054-2.

When the valve core component 1056 moves to the first position, the valve core component 1056 may simultaneously turn off the first dispense cavity body 1054-1 and the work cavity 1055, as well as the second dispense cavity body 1054-2 and the work cavity 1055, and the main water inlet 1051 communicates with the main water outlet 1052 through the first dispense cavity body 1054-1, the bypass cavity 1053 and the second dispense cavity body 1054-2.

When the valve core component 1056 moves to the second position, the valve core component 1056 may simultaneously turn off the first dispense cavity body 1054-1 and the bypass cavity 1053, as well as the second dispense cavity body 1054-2 and the bypass cavity 1053, and the main water inlet 1051 communicates with the main water outlet 1052 through the first dispense cavity body 1054-1, the work cavity 1055 and the second dispense cavity body 1054-2.

Referring to FIG. 4 and FIG. 5, in some embodiments, the valve core component 1056 includes a first ejector rod 1056-1 and a second ejector rod 1056-2. The first ejector rod 1056-1 is movably provided at the first dispense cavity body 1054-1 for controlling the water dispersion of the first dispense cavity body 1054-1. The second ejector rod 1056-2 is movably provided at the second dispense cavity body 1054-2 for controlling the water dispersion of the second dispense cavity body 1054-2.

At least a portion of the first ejector rod 1056-1 and the second ejector rod 1056-2 extends into the work cavity 1055. Since the water purification assembly 100 is connected to the adapter seat assembly 105 through the work cavity 1055, that is, the water purification assembly 100 is partially provided at the work cavity 1055.

When the water purification assembly 100 is mounted at the adapter seat assembly 105, the water purification assembly 100 extends into the work cavity 1055, contacts with the first ejector rod 1056-1 and the second ejector rod 1056-2 to squeeze the first ejector rod 1056-1 and the second ejector rod 1056-2, and both the position of the first ejector rod 1056-1 in the first dispense cavity body 1054-1, and the position of the second ejector rod 1056-2 in the second dispense cavity body 1054-2 are changed. The first ejector rod 1056-1 and the second ejector rod 1056-2 move to the second position, the first ejector rod 1056-1 turns off the first dispense cavity body 1054-1 and the bypass cavity 1053, and the second ejector rod 1056-2 turns off the second dispense cavity body 1054-2 and the bypass cavity 1053, and thus the main water inlet 1051 communicates with the main water outlet 1052 through the first dispense cavity body 1054-1, the work cavity 1055 and the second dispense cavity body 1054-2.

The first dispense cavity body 1054-1 may be either a water inflow cavity or a water outflow cavity body. Correspondingly, the second first dispense cavity body 1054-2 may be either a water outflow cavity body or a water inflow cavity body. Moreover, the water inlet and outlet directions of the first dispense cavity body 1054-1 and the second dispense cavity body 1054-2 correspond to the water inflow and outflow directions of the first flow duct 1013, the second flow duct 1014 and the third flow duct 1031.

Referring to FIG. 4 and FIG. 5, in some embodiments, when the first dispense cavity body 1054-1 is used as the water inflow cavity body and the second dispense cavity body 1054-2 is used as the water outflow cavity body, the external water source enters the first dispense cavity body 1054-1 through the main water inlet 1051, and enters the work cavity 1055 after passing through the first dispense cavity body 1054-1, and then the water enters the water purification assembly 100 through the work cavity 1055 for being filtered, and the filtered water enters the second dispense cavity body 1054-2 through the work cavity 1055, and finally flows out from the main water outlet 1052.

It should be noted that both the first ejector rod 1056-1 and the second ejector rod 1056-2 may implement a turn-off effect between two adjacent cavity bodies through variable diameter design. For example, when the position of the first ejector rod 1056-1 in the first dispense cavity body 1054-1 changes, the diameter of the first ejector rod 1056-1 proximal to the two ends is greater than the diameter at other positions, and thus the first ejector rod 1056-1 may block the connection position between the first dispense cavity body 1054-1 and the bypass cavity 1053 and the work cavity 1055, and the first dispense cavity body 1054-1 is blocked from communicating with the bypass cavity 1053, or the first dispense cavity body 1054-1 is blocked from communicating with the work cavity 1055.

The second ejector rod 1056-2 implements a turn-off effect between the second dispense cavity body 1054-2 and the adjacent bypass cavity 1053 or work cavity 1055 through variable diameter design, which is the same as the variable diameter design of the first ejector rod 1056-1 mentioned above, and will not be repeated here.

Referring to FIG. 4 and FIG. 5, in some embodiments, the adapter seat assembly 105 may further include a first elastic member 1056-3 and a second elastic member 1056-4. The first elastic member 1056-3 is sleeved at the first ejector rod 1056-1, a first end of the first elastic member 1056-3 may be connected to the first ejector rod 1056-1, and second and third ends of the first elastic member 1056-3 may be connected to the wall surface of the first dispense cavity body 1054-1.

During the mount process, the first elastic member 1056-3 may be sleeved entirely at an outer surface of the first ejector rod 1056-1, a top end of the first elastic member 1056-3 may be connected to an inner wall surface of the first dispense cavity body 1054-1, and a bottom end of the first elastic member 1056-3 may be connected to a step of the first ejector rod 1056-1. The first elastic member 1056-3 may undergo elastic deformation or restore elastic deformation during the first ejector rod 1056-1 moves upwards and downwards.

The second elastic member 1056-4 is sleeved at the second ejector rod 1056-2, a first end of the second elastic member 1056-4 may be connected to the second ejector rod 1056-2, and second and third ends of the second elastic member 1056-4 may be connected to the wall surface of the second dispense cavity body 1054-2.

During the mount process, the second elastic member 1056-4 may be mounted in the same way as the first elastic member 1056-3. That is, the second elastic member 1056-4 is sleeved entirely at the second ejector rod 1056-2, and a top end of the second elastic member 1056-4 is connected to the inner wall surface of the second dispense cavity body 1054-2, and a bottom end of the second elastic member 1056-4 is connected to a step of the second ejector rod 1056-2.

Both the first elastic member 1056-3 and the second elastic member 1056-4 may be springs or other elastic elements that may be elastically deformed under the action of an external force and may restore the elastic deformation by themselves.

As shown in FIG. 4, when the water purification assembly 100 is disassembled from the adapter seat assembly 105, that is, the water purification assembly 100 is separated from the adapter seat assembly 105, the water purification assembly 100 is disconnected from the work cavity 1055, and the valve core component 1056 is in the first position. The water purification assembly 100 is disengaged from the first ejector rod 1056-1 and the second ejector rod 1056-2 respectively, and the first ejector rod 1056-1 releases the squeezing effect on the first elastic member 1056-3, and the second ejector rod 1056-2 releases the squeezing effect on the second elastic member 1056-4. Both the first elastic member 1056-3 and the second elastic member 1056-4 restore elastic deformation, that is, change from a compressed state to a free state.

At this time, the first elastic member 1056-3 drives the first ejector rod 1056-1 to move towards the position where the work cavity 1055 is located, the first ejector rod 1056-1 is clamped at the connection between the first dispense cavity body 1054-1 and the work cavity 1055, and the first ejector rod 1056-1 turns off the water flow path between the first dispense cavity body 1054-1 and the work cavity 1055. Simultaneously, it means that the first ejector rod 1056-1 is far away from the connection between the first dispense cavity body 1054-1 and the bypass cavity 1053, and the first ejector rod 1056-1 releases the turn-off effect between the first dispense cavity body 1054-1 and the bypass cavity 1053, and the water flow path between the first dispense cavity body 1054-1 and the bypass cavity 1053 is turned on.

Correspondingly, the second elastic member 1056-4 drives the second ejector rod 1056-2 to move towards the position where the work cavity 1055 is located, the second ejector rod 1056-2 is clamped at the connection between the second dispense cavity body 1054-2 and the work cavity 1055, and the water flow path between the second dispense cavity body 1054-2 and the work cavity 1055 is turned off by the second ejector rod 1056-2. Simultaneously, it means that the second ejector rod 1056-2 is far away from the connection between the second dispense cavity body 1054-2 and the bypass cavity 1053. The second ejector rod 1056-2 releases the turn-off effect between the second dispense cavity body 1054-2 and the bypass cavity 1053, and the water flow path between the second dispense cavity body 1054-2 and the bypass cavity 1053 is turned on.

As shown in FIG. 5, when the water purification assembly 100 is mounted at the adapter seat assembly 105, that is, the water purification assembly 100 is connected to the work cavity 1055, the valve core component 1056 is in the second position, and the water purification assembly 100 provides squeeze effect on the first ejector rod 1056-1 and the second ejector rod 1056-2. Both the first ejector rod 1056-1 and the second ejector rod 1056-2 move towards the position where the bypass cavity 1053 is located. At this time, the first elastic member 1056-3 and the second elastic member 1056-4 are elastically deformed under pressure, that is, both are changed from a free state to a compressed state.

At this time, the first ejector rod 1056-1 is clamped at the connection between the first dispense cavity body 1054-1 and the bypass cavity 1053, and the water flow path between the first dispense cavity body 1054-1 and the bypass cavity 1053 is turned off by the first ejector rod 1056-1. Simultaneously, it means that the first ejector rod 1056-1 is far away from the connection between the first dispense cavity body 1054-1 and the work cavity 1055, and the first ejector rod 1056-1 releases the turn-off effect between the first dispense cavity body 1054-1 and the bypass cavity 1053, and the water flow path between the first dispense cavity body 1054-1 and the work cavity 1055 is turned on.

Correspondingly, the second ejector rod 1056-2 is clamped at the connection between the second dispense cavity body 1054-2 and the bypass cavity 1053, and the water flow path between the second dispense cavity body 1054-2 and the bypass cavity 1053 is turned off by the second ejector rod 1056-2. Simultaneously, it means that the second ejector rod 1056-2 is far away from the connection between the second dispense cavity body 1054-2 and the work cavity 1055. The second ejector rod 1056-2 releases the turn-off effect between the second dispense cavity body 1054-2 and the work cavity 1055, and the water flow path between the second dispense cavity body 1054-2 and the work cavity 1055 is turned on.

Referring to FIG. 4 and FIG. 5, in order to ensure that the valve core component 1056 has a good turn-off effect, the adapter seat assembly 105 further includes a fourth seal ring 1057 and a fifth seal ring 1058. At least one fourth seal ring 1057 is sleeved at the first ejector rod 1056-1 proximal to the work cavity 1055, and at least one fourth seal ring 1057 is sleeved at the second ejector rod 1056-2 proximal to the work cavity 1055.

At least one fifth seal ring 1058 is sleeved at the first ejector rod 1056-1 proximal to the bypass cavity 1053, and at least one fifth seal ring 1058 is sleeved at the second ejector rod 1056-2 proximal to the bypass cavity 1053.

When the valve core component 1056 is in the first position, the first ejector rod 1056-1 drives the fourth seal ring 1057 to turn off the water flow path between the first dispense cavity body 1054-1 and the work cavity 1055, and the second ejector rod 1056-2 also drives the fourth seal ring 1057 to turn off the water flow path between the second dispense cavity body 1054-2 and the work cavity 1055.

When the valve core component 1056 is in the second position, the first ejector rod 1056-1 drives the fifth seal ring 1058 to turn off the water flow path between the first dispense cavity body 1054-1 and the bypass cavity 1053, and the second ejector rod 1056-2 also drives the fifth seal ring 1058 to turn off the water flow path between the second dispense cavity body 1054-2 and the bypass cavity 1053.

Referring to FIG. 1, FIG. 2, FIG. 4 and FIG. 5, in some embodiments, the adapter seat assembly further includes a fixation seat 106, and the fixation seat 106 is used for mounting the water purification assembly 100 to a desired position, and the fixation seat 106 is detachably connected to the adapter seat assembly 105.

The adapter seat assembly 105 and the fixation seat 106 may be detachably assembled by snap connection, or other assembly modes may be adopted, such as a fixed connection, etc., and the adapter seat assembly 105 and the fixation seat 106 may also be integrally formed, and the adapter seat assembly 105 and the fixation seat 106 form an integral structure.

Referring to FIG. 2, in some embodiments, the fixation seat 106 includes a first seat body 1061 and a second seat body 1062. The second seat body 1062 is connected to a side of the first seat body 1061, and a position suitable for mounting the adapter seat body is provided at the second seat body 1062, and the adapter seat body is connected to the fixation seat 106 through the second seat body 1062.

During use, the fixation seat 106 may be fixed at an external device, the second seat body 1062 is connected to the front of the fixation seat 106, and the back of the fixation seat 106 is provided with a bolt hole for connecting with an external device. To ensure the connection effect, the second seat body 1062 is provided with a pipe seat for snapping the main water inlet 1051, and a pipe seat for snapping the main water outlet 1052. The pipe seat for snapping the main water inlet 1051 is snapped at the outer wall of the pipe of the main water inlet 1051, and the pipe seat for snapping the main water outlet 1052 is snapped at the outer wall of the pipe of the main water outlet 1052, which ensures the stability of the entire adapter seat body.

It should be noted that the main water inlet 1051 may also be provided at the first outer housing 1011, and the main water outlet 1052 may be provided at the inner housing 102. That is, the main water inlet 1051 is provided at one end of the first outer housing 1011, and the main water inlet 1051 communicates with the first flow duct 1013. Simultaneously, the main water outlet 1052 is provided at one end of the inner housing 102, and the main water outlet 1052 communicates with the third flow duct 1031.

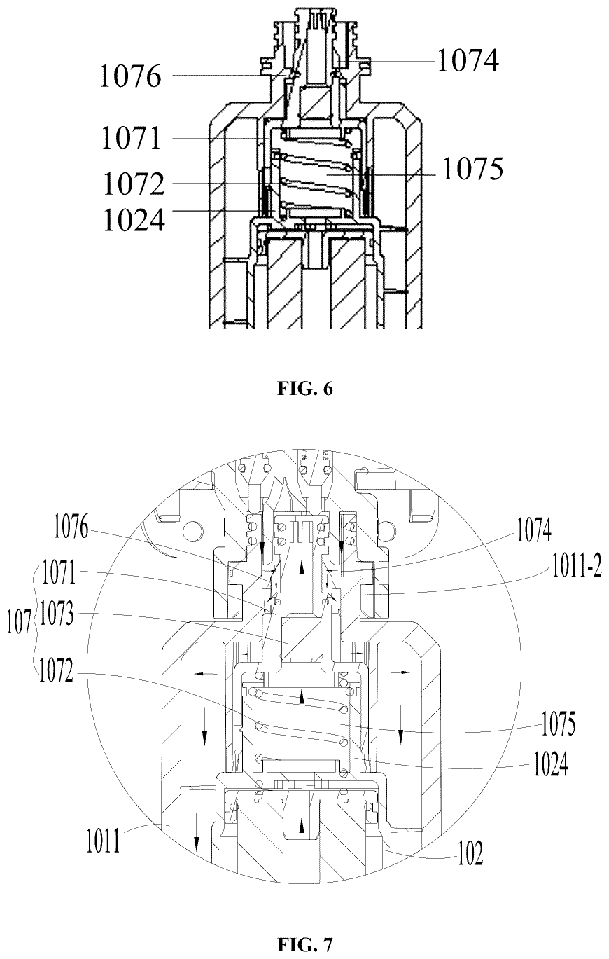

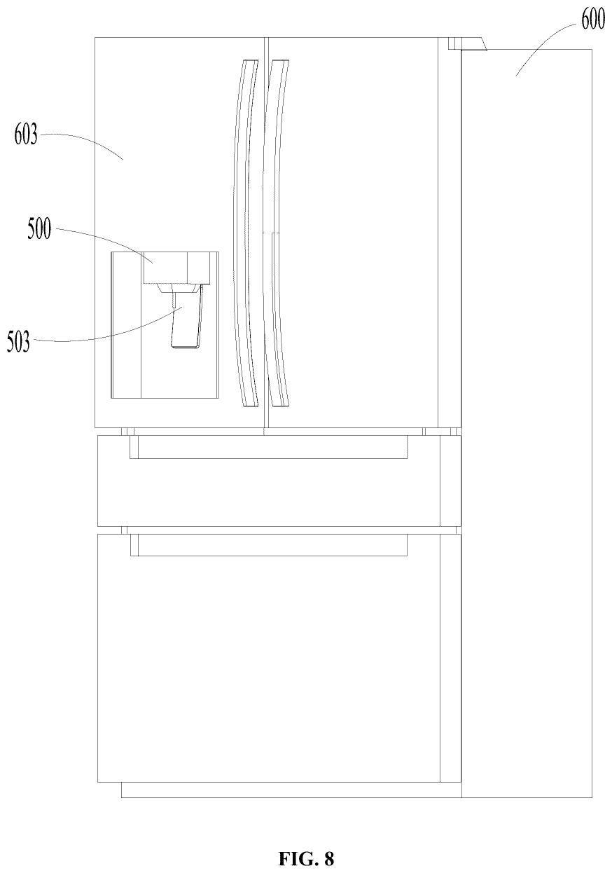

Referring to FIG. 1, FIG. 2, FIG. 6 and FIG. 7, in some embodiments, in order to prevent the water inside the water purification assembly 100 from flowing out when the filter element 103 is pulled out or replaced, the water purification assembly 100 may further include a water stop component 107. A water stop cavity 1011-2 is provided inside the first outer housing 1011 and located at the water outflow side of the filter element 103. The water stop component 107 is movably provided at the water stop cavity 1011-2, that is, the water stop component 107 is movable in the water stop cavity 1011-2 and is switchable between the first position and the second position.

Referring to FIG. 6 and FIG. 7, in some embodiments, a first duct 1074 is provided outside the water stop component 107. That is, the first duct 1074 is provided between the first outer housing 1011 and the water stop component 107, which means that the water stop component 107 is provided behind the water stop cavity 1011-2, and there is a water-passing gap between the water stop component 107 and a cavity wall of the water stop cavity 1011-2, and the water-passing gap may be turned on and turned off as the water stop component 107 moves in the water stop cavity 1011-2.

As shown in FIG. 6 and FIG. 7, a second duct 1075 is provided inside the water stop component 107, and a check valve 1073 for turning on and turning off based on the pressure difference is provided at the second duct 1075. The check valve 1073 may not only be used to limit the flow direction of the water, but also may turn on or turn off the water path based on the pressure difference on both sides thereof.

As shown in FIG. 6, when the water stop component 107 is in the first position, the water stop component 107 may turn off the first duct 1074. At this time, the check valve 1073 determines that the pressure difference at both sides is small and turns off the water path, that is, the check valve 1073 turns off the second duct 1075.

The water stop component 107 is detachably connected to the adapter seat assembly 105. When it is determined that the filter element 103 is to be pulled out or replaced, the water purification assembly 100 is disassembled from the adapter seat assembly 105. At this time, the water stop component 107 moves to the outside of the first outer housing 1011 to abut against the inner wall of the first outer housing 1011, that is, the water stop component 107 abuts against the cavity wall of the water stop cavity 1011-2, and the first duct 1074 is turned off, and the water cannot flow through the first duct 1074; the check valve 1073 determines that the pressure difference on both sides is small, and also turns off the second duct 1075, and the water cannot flow through the second duct 1075 to implement the water stop function of the water stop component 107.

As shown in FIG. 7, when the water stop component 107 is in the second position, the water stop component 107 may turn on the first duct 1074. At this time, the check valve 1073 determines that the pressure difference at both sides is large and turns on the water path, that is, the check valve 1073 turns on the second duct 1075.

As shown in FIG. 7, the water purification assembly 100 is assembled on the adapter seat assembly 105. The adapter seat assembly 105 squeezes the water stop component 107 to move the water stop component 107 towards the inside of the first outer housing 1011. At this time, there is a water-passing gap between the water stop component 107 and the first outer housing 1011, which means that the water stop component 107 turns on the first duct 1074, and the water may flow through the first duct 1074; the check valve 1073 determines that the pressure difference on both sides is large, and further turns on the second duct 1075, and the water may flow through the second duct 1075 to implement the normal working state of the water stop component 107.

By detachably connecting the water stop component 107 to the water purification assembly 100, when it is determined that the filter element 103 is to be pulled out or replaced, the water purification assembly 100 is disassembled from the adapter seat assembly 105. Since the water stop component 107 is provided at the water outflow side of the water purification assembly 100, the water stop component 107 may block the water in the water purification assembly 100 from continuing to overflow, and dirty water is effectively prevented from overflowing when the user plugs in and pull out the filter element 103, which improves the user's experience of replacing the filter element.

Referring to FIG. 2, FIG. 6 and FIG. 7, in some embodiments, the water stop component 107 may include a water stop housing 1071, and the water stop housing 1071 is a shell-like structure with an accommodation cavity provided inside the water stop housing 1071. The inner housing 102 is located on the water outflow side of the filter element 103 and extends outward to form a fixation portion 1024, and the shape of the water stop housing 1071 is compatible with the shape of the fixation portion 1024. The water stop housing 1071 may be sleeved outside the fixation portion 1024, or the water stop housing 1071 may be sleeved inside the fixation portion 1024, and the water stop housing 1071 moves along the outer wall or inner wall of the fixation portion 1024.

Referring to FIG. 2, FIG. 6 and FIG. 7, in some embodiments, an elastic member 1072 is provided inside the water stop housing 1071, a first end of the elastic member 1072 is connected to the cavity wall of the accommodation cavity, and a second end of the elastic member 1072 is connected to the fixation portion 1024. When the elastic member 1072 is elastically deformed under pressure, the fixation portion 1024 may be completely accommodated in the accommodation cavity; when the elastic member 1072 recovers its elastic deformation, the water stop housing 1071 moves in the water stop cavity 1011-2 due to the elastic restoring force of the elastic member 1072 and the fixation portion 1024 is exposed from the accommodation cavity. The water stop housing 1071 is movably provided at the fixation portion 1024 through the elastic member 1072, that is, the water stop housing 1071 is movable relative to the fixation portion 1024, where the elastic member 1072 may be a spring.

In some embodiments, the second duct 1075 may be formed inside the water stop housing 1071, and the second duct 1075 may also be partially formed inside the fixation portion 1024 and partially formed inside the water stop housing 1071. The second duct 1075 may also be provided at the water stop housing 1071 or the fixation portion 1024.

As shown in FIG. 6, when it is determined that the filter element 103 is to be pulled out or replaced, the water stop component 107 is disassembled from the adapter seat assembly 105, which means that the squeezing effect of the adapter seat assembly 105 on the water stop housing 1071 is removed. The elastic member 1072 restores its elastic deformation, drives the water stop housing 1071 to move axially along the fixation portion 1024 until the water stop housing 1071 abuts against the inner wall of the first outer housing 1011, and the water-passing gap between the water stop housing 1071 and the first outer housing 1011 disappears. At this time, the water stop component 107 is in the first position, and turns off the first duct 1074. The check valve 1073 determines that the pressure difference between the two ends is small, and turns off the second duct 1075 to implement the water stop function of the water stop component 107.

As shown in FIG. 7, when the water stop component 107 is mounted at the adapter seat assembly 105, it means that the adapter seat assembly 105 exerts squeezing effect on the water stop housing 1071, the position of the fixation portion 1024 remains unchanged, the elastic member 1072 is elastically deformed under pressure, and the water stop housing 1071 moves along the axial direction of the fixation portion 1024. There is a water-passing gap between the inner wall of the first outer housing 1011. At this time, the water stop component 107 is in the second position, the first duct 1074 is turned on, and the check valve 1073 determines that the pressure difference on both sides is large, and controls the second duct 1075 to be turned on, and the water purification assembly 100 is in a normal working state.

Referring to FIG. 2, FIG. 6 and FIG. 7, in some embodiments, in order to make the water stop effect of the water stop component 107 better, the water stop component 107 may also include a sixth seal ring 1071-2, and the sixth seal ring 1071-2 is sleeved at the water stop housing 1071 and may move upwards and downwards in the water stop cavity 1011-2 with the movement of the water stop housing 1071. The sixth seal ring 1071-2 may be a rubber seal ring.

As shown in FIG. 6, when it is determined that the filter element 103 is to be pulled out or replaced, the water stop component 107 is disassembled from the adapter seat assembly 105, which means that the squeezing effect of the adapter seat assembly 105 on the water stop housing 1071 is removed. The elastic member 1072 restores its elastic deformation, drives the water stop housing 1071 to move axially along the fixation portion 1024. The sixth seal ring 1071-2 moves with the water stop housing 1071 to form a seal surface with the inner wall of the water stop cavity 1011-2 to turn off the first duct 1074. The check valve 1073 determines that the pressure difference between the two ends is small, and turns off the second duct 1075 to implement the water stop function of the water stop component 107.

As shown in FIG. 7, when the water stop component 107 is mounted at the adapter seat assembly 105, it means that the adapter seat assembly 105 exerts squeezing effect on the water stop housing 1071, the position of the fixation portion 1024 remains unchanged, the elastic member 1072 is elastically deformed under pressure, and the water stop housing 1071 moves along the axial direction of the fixation portion 1024. The sixth seal ring 1071-2 moves with the water stop housing 1071, releases the seal surface formed with the inner wall of the water stop cavity 1011-2 to turn on the first duct 1074. The check valve 1073 determines that the pressure difference on both sides is large, and controls the second duct 1075 to be turned on, and the water purification assembly 100 is in a normal working state.

Referring to FIG. 2, FIG. 6 and FIG. 7, in some embodiments, in order to make the water stop effect of the water stop component 107 better, a seal protrusion 1076 may further be provided at the inner side wall of the first outer housing 1011. The seal protrusion 1076 is located at the inner side wall of the water stop cavity 1011-2, and used for implementing the water stop function in combination with the sixth seal ring 1071-2. The seal protrusion 1076 may be partially provided at the inner side wall of the first outer housing 1011, or may be provided as an annular structure along the radial direction of the first outer housing 1011.

As shown in FIG. 6, when it is determined that the filter element 103 is to be pulled out or replaced, the water stop component 107 is disassembled from the adapter seat assembly 105, which means that the squeezing effect of the adapter seat assembly 105 on the water stop housing 1071 is removed. The elastic member 1072 restores its elastic deformation, drives the water stop housing 1071 to move axially along the fixation portion 1024. The sixth seal ring 1071-2 moves with the water stop housing 1071 and abuts against the seal protrusion 1076 to form a seal surface to turn off the first duct 1074. The check valve 1073 determines that the pressure difference between the two ends is small, and turns off the second duct 1075 to implement the water stop function of the water stop component 107.

In some embodiments, as shown in FIG. 7, when the water stop component 107 is mounted at the adapter seat assembly 105, it means that the adapter seat assembly 105 exerts squeezing effect on the water stop housing 1071, the elastic member 1072 is elastically deformed under pressure, and the water stop housing 1071 moves along the axial direction of the fixation portion 1024. The sixth seal ring 1071-2 moves with the water stop housing 1071, release the seal surface formed between the seal protrusion 1076 to turn on the first duct 1074. The check valve 1073 determines that the pressure difference on both sides is large, and controls the second duct 1075 to be turned on, and the water purification assembly 100 is in a normal working state.

Referring to FIG. 2, FIG. 6 and FIG. 7, in some embodiments, the water stop component 107 may further include at least one seventh seal ring 1071-3, that is, the water stop component 107 includes one or two seventh seal rings 1071-3. The seventh seal ring 1071-3 is coaxially provided with the sixth seal ring 1071-2, and is also sleeved at the water stop housing 1071, and moves synchronously with the water stop housing 1071.

The seventh seal ring 1071-3 may be a rubber seal ring and is provided at an end of the water stop housing 1071 facing the adapter seat assembly 105, and the water stop component 107 may ensure good seal between the water stop housing 1071 and the adapter seat assembly 105 during the position switch process.

Referring to FIG. 2, FIG. 6 and FIG. 7, in some embodiments, in order to ensure a good seal effect between the water stop housing 1071 and the fixation portion 1024 during the position switch process of the water stop component 107, the water stop component 107 may further include a second seal ring 1023, and the second seal ring 1023 is sleeved at the fixation portion 1024 and is located between the water stop housing 1071 and the fixation portion 1024. The second seal ring 1023 may be a rubber seal ring, and is used for ensuring the seal property between the water stop housing 1071 and the fixation portion 1024 during the movement of the water stop component 107.

Referring to FIG. 2, FIG. 6 and FIG. 7, in some embodiments, in order to prevent the water stop housing 1071 from disengaging from the fixation portion 1024, a limit protrusion 1022 is provided at the fixation portion 1024, and a limit groove 1071-1 is provided at a position of the water stop housing 1071 corresponding to the limit protrusion 1022. The limit groove 1071-1 is slidably sleeved at the limit protrusion 1022, and the water stop housing 1071 moves relative to the fixation portion 1024 within the stroke limited by the limit groove 1071-1, which prevents the water stop housing 1071 from disengaging from the fixation portion 1024.

When the water stop component 107 is in the first position, the elastic member 1072 restores its elastic deformation, drives the water stop housing 1071 to move along the axial direction of the fixation portion 1024, the limit protrusion 1022 abuts against a first side of the limit groove 1071-1. When the water stop component 107 is in the second position, the elastic member 1072 is compressed and elastically deformed, and the water stop housing 1071 moves along the axial direction of the fixation portion 1024, the limit protrusion 1022 abuts against a second side of the limit groove 1071-1.

The cooperation between the limit protrusion 1022 and the limit groove 1071-1 may not only prevent the water-stop component 107 from disengaging from the fixation portion 1024, but also further ensure the water stop function of the water stop component 107. The water stop component 107 is 1 in the first position to turn off the first duct 1074, and the check valve 1073 determines that the pressure difference between the two ends is small, and turns off the second duct 1075, to implement the water stop function of the water stop component 107. The water-stop component 107 is in the second position to turn on the first duct 1074, and the check valve 1073 determines that the pressure difference between the two ends is large, and turn on the second duct 1075.

Referring to FIG. 2, FIG. 6 and FIG. 7, in some embodiments, in order to ensure that the water stop component 107 may move along a certain path, a guide structure may also be provided between the water stop component 107 and the fixation portion 1024. The guide structure may include a guide protrusion 1025 provided at the outer wall of the fixation portion 1024, and a guide groove (not shown in the figure) provided at the inner wall of the water stop housing 1071 corresponding to the position of the guide protrusion 1025. When the water stop housing 1071 moves along the outer wall of the fixation portion 1024, the guide protrusion 1025 moves in the guide groove.

Positions and shapes of the guide groove and the guide protrusion 1025 may be adjusted according to the use requirements. The guide protrusion 1025 may be provided along the axial direction of the fixation portion 1024, and the water stop component 107 moves upwards and downwards along the axial direction of the fixation portion 1024.

It should be noted that the first duct 1074 may be provided as a water inflow duct or a water outflow duct. Similarly, the second duct 1075 may be provided as a water inflow duct or a water outflow duct. When the first duct 1074 and the second duct 1075 are used as water inflow ducts or water outflow ducts, they may correspond to the water inflow and outflow directions of the first flow duct 1013, the second flow duct 1014 and the third flow duct 1031.

Referring to FIG. 2, FIG. 6 and FIG. 7, when the first duct 1074 is the water inflow duct and the second duct 1075 is the water outflow duct, the first duct 1074 communicates with the first flow duct 1013, and the second duct 1075 communicates with the third flow duct 1031. The water stop component 107 is assembled at the water purification assembly 100, and then the water purification assembly 100 with the water stop component 107 is assembled on the adapter seat assembly 105. The water enters the first duct 1074 from the main water inlet 1051, and then flows into the first flow duct 1013 from the first duct 1074. After entering the water storage cavity 1041 from the first flow duct 1013, the water may be temporarily stored in the water storage cavity 1041. When the user needs water, part of the water in the water storage cavity 1041 enters the second flow duct 1014, and then penetrates from the second flow duct 1014 to the filter element 103 for being filtered. The water filtered by the filter element 103 flows out from the third flow duct 1031 inside the filter element 103, enters the second duct 1075, and flows out from the second duct 1075 to the main water outlet 1052.

It should be noted that during the assembly process of the water purification assembly 100, the first block member 1044, the second block member 1032, and the third seal ring 1032-1 may be respectively bonded and fixed to the two ends of the filter element 103 by food-grade glue. The second seal ring 1023 is then assembled at the inner housing 102, and the inner housing 102 is sleeved outside the filter element 103 that has been encapsulated at both ends. The sixth seal ring 1071-2 and the seventh seal ring 1071-3 are assembled at the corresponding positions of the water stop housing 1071, the check valve 1073 and the elastic member 1072 are mounted inside the water stop housing 1071 to form the water stop component 107.

The water stop housing 1071 is then snapped at the fixation portion 1024 through the cooperation of the limit groove 1071-1 and the limit protrusion 1022 to assemble the water stop housing 1071 and the inner housing 102. Finally, the first outer housing 1011 is embedded from the top of the inner housing 102, and the second outer housing 1012 is pushed against the bottom of the support member 104 to complete the abutting of the first outer housing 1011 and the second outer housing 1012, and the first outer housing 1011 and the second outer housing 1012 are rotated and welded to complete the overall assembly of the water purification assembly 100.

One or more solutions of the water purification assembly 100 provided by some embodiments of the present application mentioned above have at least one of the following effects.

By providing the water storage cavity 1041 for storing water in the water purification assembly 100, the integration degree of the water purification assembly 100 is higher, and the water purification assembly 100 has not only a purification function but also a water storage function. The water tank structure provided at the independent water purification assembly 100 in the related art is replaced with the water storage cavity 1041, that is, the water tank is removed, the structural design of the water path system is simplified and the occupation space of the water path system is reduced. Simultaneously, connection pipelines and connection joints between the water tank and the water purification assembly 100 are removed, the risk of water leakage of the structure is effectively avoided. This makes the product more reliable and provides a better user experience.

By improving the water purification assembly 100, the water path system is streamlined. After the water purification assembly 100 is replaced, the replacement of the water storage space in the entire water system may be completed, which further ensures the safety of water usage for users.

By providing a spiral flow duct in the water purification assembly 100, after being input from the main water inlet 1051, water flows to the water storage cavity 1041 along the extension direction of the spiral flow duct. It means that the flow path of the water in the spiral flow duct is prolonged, the water first flowing into the water purification assembly 100 flows out of the water purification assembly 100 first. That is, the first-in-first-out of the water is realized, which may effectively prevent the accumulation of stale water and the occurrence of mixed water.

By detachably connecting the water stop component 107 to the water purification assembly 100, when it is determined that the filter element 103 is to be pulled out or replaced, the water purification assembly 100 is disassembled from the adapter seat assembly 105. Since the water stop component 107 is provided at the water outflow side of the water purification assembly 100, the water stop component 107 may block the water in the water purification assembly 100 from continuing to overflow, and dirty water is effectively prevented from overflowing when the user plugs in and out the filter element 103, which improves the user's experience of replacing the filter element.

Referring to FIG. 8 and FIG. 9, the present application further provides a refrigeration device 600, including a refrigeration compartment and a water-usage device 500, and the above-mentioned water purification assembly 100. The water purification assembly 100 is provided at the refrigeration compartment, and the main water outlet 1052 of the water purification assembly 100 communicates with the water-usage device 500.

In some embodiments of the present application, the refrigeration device 600 further includes a valve component 200, a liquid inlet of the valve component 200 communicates with the main water outlet 1052 of the water purification assembly 100, and a liquid outlet of the valve component 200 communicates with at least one water-usage device 500.

In some embodiments of the present application, the water-usage device 500 includes a first ice maker 501, a second ice maker 502 and a dispenser 503. The refrigeration compartment includes a refrigerator compartment 601 and a freezer compartment 602, the first ice maker 501 is provided at the refrigerator compartment 601, the second ice maker 502 is provided at the freezer compartment 602, and the dispenser 503 is provided at a door body 603 of the refrigeration device 600.

In some applications of the present application, as shown in FIG. 9, the water purification assembly 100 may be mounted in the refrigerator compartment 601, and the refrigeration device 600 further includes a plurality of water supply pipelines, a first end of one water supply pipeline is used for communicating with the water supply system (tap water network), and a second end of the water supply pipeline extends into the refrigerator compartment 601 and communicates with the main water inlet 1051 of the water purification assembly 100. Since the water purification assembly 100 is provided at the refrigerator compartment 601, the water entering the water purification assembly 100 may be cooled first and then filtered in the low temperature environment of the refrigerator compartment 601, and the filtered low-temperature purified water is supplied to each water-usage device 500, and the user may directly take the cooled water from the dispenser 503 for use.

During the use of the refrigeration device 600, the water purification assembly 100 may be connected externally to a tap water pipeline, that is, an external water source, and the valve component 200 may be a one-inlet-three-outlet valve, and has a liquid inlet and three liquid outlets. The liquid inlet of the valve component 200 communicates with the main water outlet 1052 of the water purification assembly 100, and each liquid outlet of the valve component 200 communicates with the first ice maker 501, the second ice maker 502 and the dispenser 503 through corresponding connecting pipes, respectively, and the water purified by the water purification assembly 100 may be selectively dispensed to the first ice maker 501, the second ice maker 502 and the dispenser 503 of the refrigeration device 600.

The purified water output by the water purification assembly 100 is controllably dispensed to the first ice maker 501, the second ice maker 502 and the dispenser 503 through the one-inlet-three-outlet valve, which may meet the ice-making needs of the first ice maker 501 and the second ice maker 502, and the user may also use ice water through the dispenser 503 without opening the door body 603, which is more convenient to use.

Further, by providing a water storage cavity 1041 in the water purification assembly 100, the traditional water tank structure is integrated with the water purification assembly 100, and the water supply water path structure of the water-usage device 500 is simplified. The simplified water supply water path may not only prolong the flow path of the internal water, but also facilitate the first-in-first-out of the water. Simultaneously, water may be stored in the water storage cavity 1041. After the water purification assembly 100 is mounted entirely in the cold storage room, the water storage cavity 1041 cools the internal water using the temperature of the refrigerator compartment. The cooled water is supplied to the dispenser 503, which may improve the user experience.

According to the refrigeration device of the present embodiment, by providing the water storage cavity 1041 for storing water in the water purification assembly 100, the integration degree of the water purification assembly 100 is higher, and the water purification assembly 100 has not only a purification function but also a water storage function. The water tank independently provided at for the water purification assembly in the related art is replaced with the water storage cavity, that is, the water tank is removed. The design of the structure is simplified and the occupation space of the structure is reduced. Simultaneously, connection pipelines and connection joints between the water tank and the water purification assembly 100 are removed, the risk of water leakage of the structure is effectively avoided. This makes the product more reliable and provides a better user experience.

Finally, it should be noted that the above embodiments are only used to illustrate the present application, but not to limit the present application. Although the application has been described in detail with reference to some embodiments, those skilled in the art should understand that various combinations, modifications, or equivalent replacements of the technical solutions of the application do not depart from the spirit and scope of the technical solutions of the application, and should all cover the scope of the claims of this application.

1. A water supply system for a refrigeration device, comprising:
a water purification assembly;
a first water path for connecting an external water source to a water inflow end of the water purification assembly; and
a second water path connected to a water outflow end of the water purification assembly to selectively supply water from the water purification assembly to a water-usage device.

2. The water supply system of claim 1, further comprising: a valve component, wherein a liquid inlet of the valve component communicates with the water outflow end of the water purification assembly, and a liquid outlet of the valve component is connected to the second water path.

3. The water supply system of claim 2, wherein the second water path comprises a first water supply pipe assembly and a second water supply pipe, where the first water supply pipe assembly is used for connecting the valve component to an ice maker unit of the water-usage device, and the second water supply pipe is used for connecting the valve component to a dispenser of the water-usage device.

4. The water supply system of claim 3, wherein the ice maker unit comprises a first ice maker provided at a refrigeration compartment and a second ice maker provided at a freezer compartment; and
the first water supply pipe assembly comprises a first water supply sub-pipe and a second water supply sub-pipe, the first water supply sub-pipe is used for connecting the valve component to the first ice maker, and the second water supply sub-pipe is used for connecting the valve component to the second ice maker.

5. The water supply system of claim 1, wherein the water purification assembly comprises:
an outer housing assembly, provided with an accommodation cavity;
a filter element, provided inside the accommodation cavity;
an inner housing, provided between the outer housing assembly and the filter element, where a first flow duct is provided between the inner housing and the outer housing assembly, the first flow duct communicates with a main water inlet, and the main water inlet communicates with the first water path; a second flow duct is provided between the inner housing and the filter element; a third flow duct is provided inside the filter element, the third flow duct communicates with a main water outlet, and the main water outlet communicates with the second water path; and
a support member, for supporting the filter element, where a water storage cavity is provided between the support member and a bottom wall of the outer housing assembly, and the water storage cavity communicates with the first flow duct and the second flow duct respectively.

6. The water supply system of claim 5, wherein at least one of the first flow duct and the second flow duct is provided with a guide portion, and the guide portion extends along a central axis of the inner housing to form a spiral structure.

7. The water supply system of claim 5, further comprising an adapter seat assembly, wherein the adapter seat assembly comprises:
an adapter seat body, where the main water inlet and the main water outlet are provided at the adapter seat body, and the adapter seat body is further provided with a bypass cavity, a dispense cavity and a work cavity, the bypass cavity communicates with the work cavity through the dispense cavity, and the work cavity is used for being detachably connected to the water purification assembly; and
a valve core component, movably provided in the dispense cavity and being switchable between a first position and a second position;
in the first position, the valve core component turns off the dispense cavity and the work cavity, and the main water inlet communicates with the main water outlet through the dispense cavity and the bypass cavity; and
in the second position, the valve core component turns off the dispense cavity and the bypass cavity, and the main water inlet communicates with the main water outlet through the dispense cavity and the work cavity.

8. The water supply system of claim 5, further comprising a water stop component, wherein a water stop cavity is provided inside the outer housing assembly, and the water stop component is movably provided at the water stop cavity, and is switchable between a first position and a second position;
a first duct is provided outside the water stop component, a second duct is provided inside the water stop component, and a check valve is provided at the second duct;
in the first position, the water stop component turns off the first duct, and the check valve turns off the second duct; and
in the second position, the water stop component turns on the first duct, and the check valve turns on the second duct.

9. A refrigeration device, comprising a refrigeration compartment, a water-usage device, and a water supply system for the refrigeration device, comprising:
a water purification assembly;
a first water path for connecting an external water source to a water inflow end of the water purification assembly; and
a second water path connected to a water outflow end of the water purification assembly to selectively supply water from the water purification assembly to a water-usage device;
the water purification assembly is provided at the refrigeration compartment, a liquid inlet of a valve component communicates with a main water outlet of the water purification assembly, and a liquid outlet of the valve component communicates with at least one of the water-usage devices.

10. The refrigeration device of claim 9, wherein the water-usage device comprises a first ice maker, a second ice maker and a dispenser; and
the refrigeration compartment comprises a refrigerator compartment and a freezer compartment, the first ice maker is provided at the refrigerator compartment, the second ice maker is provided at the freezer compartment, and the dispenser is provided at a door body of the refrigeration device.

11. The refrigeration device of claim 9, wherein the water supply system for the refrigeration device further comprises: the valve component, wherein the liquid inlet of the valve component communicates with the water outflow end of the water purification assembly, and the liquid outlet of the valve component is connected to the second water path.

12. The refrigeration device of claim 11, wherein the second water path comprises a first water supply pipe assembly and a second water supply pipe, where the first water supply pipe assembly is used for connecting the valve component to an ice maker unit of the water-usage device, and the second water supply pipe is used for connecting the valve component to a dispenser of the water-usage device.

13. The refrigeration device of claim 12, wherein the first water supply pipe assembly comprises a first water supply sub-pipe and a second water supply sub-pipe, the first water supply sub-pipe is used for connecting the valve component to a first ice maker, and the second water supply sub-pipe is used for connecting the valve component to a second ice maker.

14. The refrigeration device of claim 9, wherein the water purification assembly comprises:
an outer housing assembly provided with an accommodation cavity;
a filter element provided inside the accommodation cavity;
an inner housing provided between the outer housing assembly and the filter element, where a first flow duct is provided between the inner housing and the outer housing assembly, the first flow duct communicates with a main water inlet, and the main water inlet communicates with the first water path; a second flow duct is provided between the inner housing and the filter element; a third flow duct is provided inside the filter element, the third flow duct communicates with the main water outlet, and the main water outlet communicates with the second water path; and
a support member, for supporting the filter element, where a water storage cavity is provided between the support member and a bottom wall of the outer housing assembly, and the water storage cavity communicates with the first flow duct and the second flow duct respectively.

15. The refrigeration device of claim 14, wherein at least one of the first flow duct and the second flow duct is provided with a guide portion, and the guide portion extends along a central axis of the inner housing to form a spiral structure.

16. The refrigeration device of claim 14, wherein the water supply system further comprises an adapter seat assembly, wherein the adapter seat assembly comprises:
an adapter seat body, where the main water inlet and the main water outlet are provided at the adapter seat body, and the adapter seat body is further provided with a bypass cavity, a dispense cavity and a work cavity, the bypass cavity communicates with the work cavity through the dispense cavity, and the work cavity is used for being detachably connected to the water purification assembly; and
a valve core component, movably provided in the dispense cavity and being switchable between a first position and a second position;
in the first position, the valve core component turns off the dispense cavity and the work cavity, and the main water inlet communicates with the main water outlet through the dispense cavity and the bypass cavity; and
in the second position, the valve core component turns off the dispense cavity and the bypass cavity, and the main water inlet communicates with the main water outlet through the dispense cavity and the work cavity.

17. The refrigeration device of claim 14, wherein the water supply system further comprises a water stop component, wherein a water stop cavity is provided inside the outer housing assembly, and the water stop component is movably provided at the water stop cavity, and is switchable between a first position and a second position;
a first duct is provided outside the water stop component, a second duct is provided inside the water stop component, and a check valve is provided at the second duct;
in the first position, the water stop component turns off the first duct, and the check valve turns off the second duct; and
in the second position, the water stop component turns on the first duct, and the check valve turns on the second duct.
